(19) United States
(12) Patent Application Publication
(10) Pub. No.: US 2019/0086338 A1
(43) Pub. Date: Mar. 21, 2019

(54) Automatic Vehicle Fluid Detection Sheet

(71) Applicant: Steven Bailey, San Jose, CA (US)

(72) Inventor: Steven Bailey, San Jose, CA (US)

(21) Appl. No.: 15/708,397

(22) Filed: Sep. 19, 2017

(51) Int. Cl. G01N 21/78

(52) U.S. Cl. CPC G01N 21/78; G01N 2021/7759

(57) ABSTRACT

The current invention is an automotive fluid identifier sheet. The sheet is a treated paper that will react to the liquids that drip from the vehicle to change colors. Examples of fluids in a regular car are Gas, Transmission fluid, Windshield wiper fluid, Brake fluid, and Power steering fluid. The sheet will assign a different color to each fluid to show which fluid to show the users what fluid has leaked.

### CROSS-REFERENCES TO RELATED APPLICATIONS (IF ANY)

None.

### BACKGROUND

### 1. Field of the Invention

The present invention generally relates to identifying fluids dripping from a vehicle and more specifically a sheet that goes below a vehicle.

### 2. Description of Prior Art

A person doesn't have to be a car enthusiast or professional mechanic to know that leaking fluid from their car is potentially problematic. But how do they tell if they have serious problems on their hands or something that can be fixed with a simple inspection?

There is still room for improvement in the art.

### SUMMARY OF THE INVENTION

The current invention is Automotive Fluid Identifier system and device that is easily and safe to use.

The Automotive Fluid Identifier sheet is placed and located below the vehicle. It will identify the type of fluid that the vehicle is losing and giving an idea of how much it will cost to fix,

The majority of leaks coming off a vehicle indicate a potential problem to a vehicle. To understand what that fluid is will help the owner diagnose the problem.

The current invention is an automotive fluid identifier sheet which a treated paper that will react to the liquid drip to change colors and help the owner identify the problem and the potential repair cost.

### BRIEF DESCRIPTION OF THE DRAWINGS

Without restricting the full scope of this invention, the preferred form of this invention is illustrated in the following drawings:

FIG. 1 shows the current invention being used;

FIG. 2 is shows a top view of the current invention;

FIG. 3 shows another view of the invention; and

FIG. 4 shows another view of the current invention.

### DESCRIPTION OF THE PREFERRED EMBODIMENT

There are a number of significant design features and improvements incorporated within the invention.

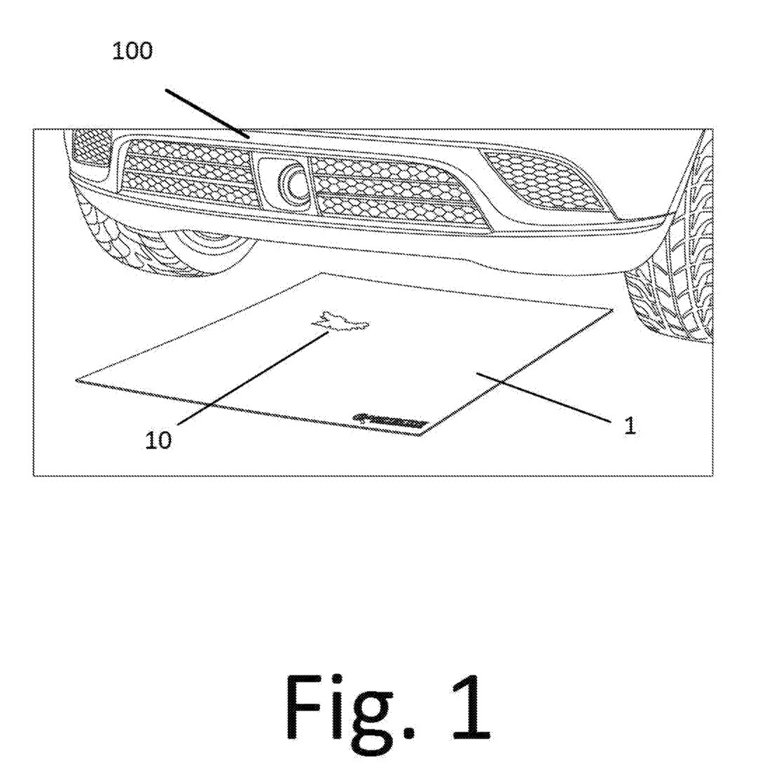

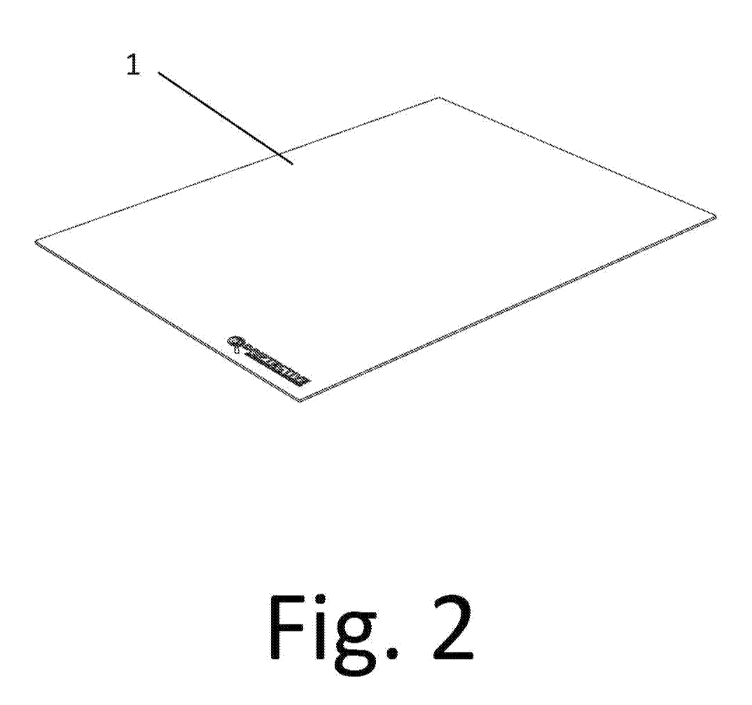

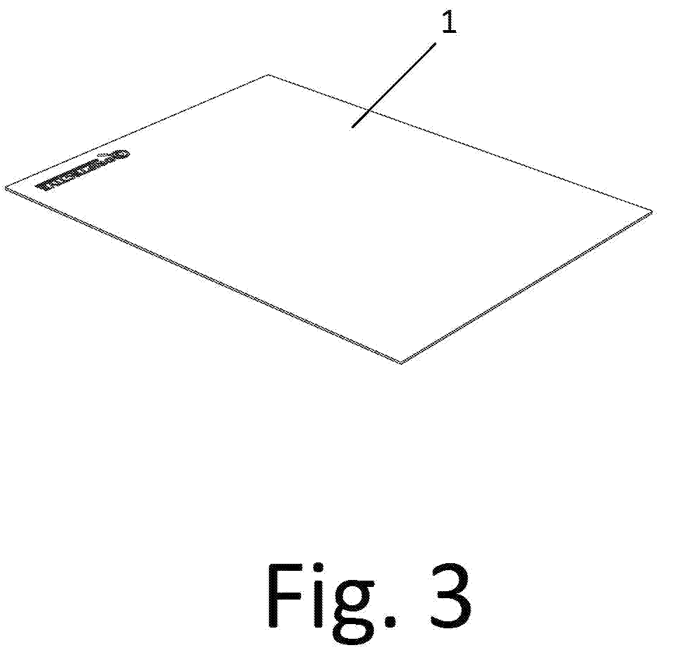

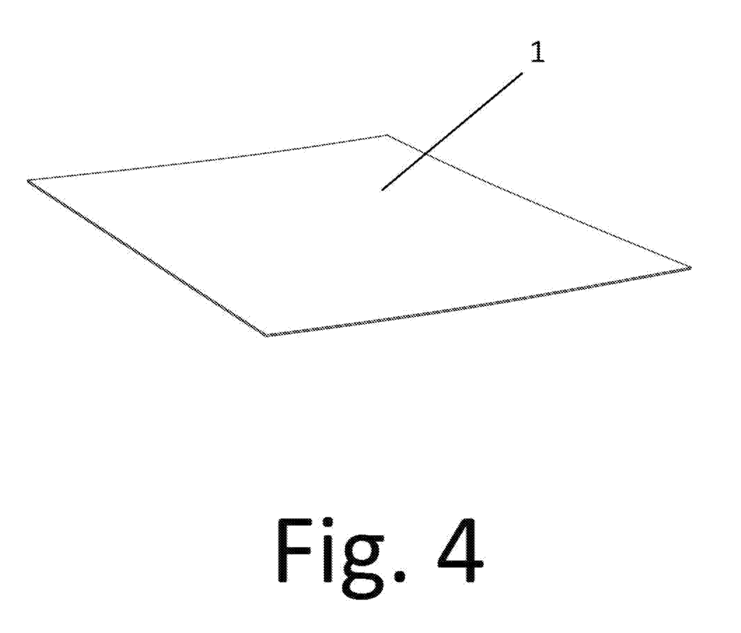

As shown in FIGS. 1 through 4, the current invention is a vehicle drip identification system and device that is easily and safe to use. The present invention gives an easy way to identify what the fluid is that drips from a vehicle. The majority of leaks coming off a vehicle indicate a potential problem to a vehicle. To understand what that fluid is will help the owner diagnose the problem.

If a vehicle owner doesn't know brake fluid from coolant or power steering fluid from gas, they can find out in a matter of seconds with the automotive fluid Identifier sheet 1.

The Automotive Fluid Identifier sheet 1 is placed and located below the vehicle 100. It will identify the type of fluid that the vehicle is losing and giving an idea of how much it will cost to fix. The sheet 1 would change colors on the spot 10 the drip occurred and identify if it was transmission fluid, power steering fluid, coolant, etc. Samples could be blue for one fluid, red for another, etc

The Automotive Fluid Identifier sheet 1 is a treated paper that will react to the liquid drip spot 10 to change colors. Examples of fluids in a regular car are Gas, Transmission fluid, Windshield wiper fluid, Brake fluid, and Power steering fluid. The sheet 1 will assign a different color to each fluid to identify each fluid to show the users what fluid has leaked. It is a flat sheet 1 rectangular in shape with the sized depended on the vehicle 100 that it is being used with.

Operation

The Automotive Fluid Identifier sheet 1 is placed under the vehicle 100 under the engine block. If there is a fluid leak the leak will drip onto the sheet 1. The sheet 1 will change color at the spot 10 of the leak.

Advantage.

The fluid identification sheet is simple to use, just place the treated AFI paper at the leakage site. The user can find out what type of fluid the vehicle is losing in seconds which can prevent small issues from becoming big problems.

As to a further discussion of the manner of usage and operation of the present invention, the same should be apparent from the above description. Accordingly, no further discussion relating to the manner of usage and operation will be provided. With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

That which is claimed is:

1. A device comprising:
automotive fluid identifier sheet that will change colors when a fluid is placed on it where the color is unique to the fluid.

2. A device according to claim 1 comprising:
Being comprised of a flat paper sheet.

3. A device according to claim 1 comprising:
Where the fluid comprises of one or more of a set of Gas, Transmission fluid, Windshield wiper fluid, Brake fluid, and Power steering fluid.

4. A device according to claim 1 comprising:
Where the sheet is placed under a vehicle.
